(19) United States
(12) Patent Application Publication
(10) Pub. No.: US 2016/0112242 A1
(43) Pub. Date: Apr. 21, 2016

(54) DOCSIS PROVISIONING OF POINT-TO-POINT ETHERNET

(71) Applicant: Oliver Solutions Ltd., Herzliya (IL)

(72) Inventors: Mark Chanukaev, Pardes Hana (IL); Roy Arav, Tel Aviv (IL); David Ganor, Shimshit (IL); Daniel Greenberg, Rishon-Lezion (IL)

(21) Appl. No.: 14/886,055

(22) Filed: Oct. 18, 2015

Related U.S. Application Data
(60) Provisional application No. 62/065,683, filed on Oct. 19, 2014.
(60) Provisional application No. 62/077,990, filed on Nov. 11, 2014.

(51) Int. Cl. H04L 12/24; H04L 29/12; H04L 29/08

(52) U.S. Cl. CPC H04L 41/042; H04L 67/104; H04L 61/2015; H04L 41/0806

(57) ABSTRACT

A system for provisioning of point-to-point Ethernet data services via a cable provisioning infrastructure, including CPEs, and floor switches that include customer-facing ports, each CPE being connected to a customer-facing port, and a cable operator distribution hub, including aggregation switches, each floor switch being connected to one aggregation switch, a gateway server, and an operations support system server provisioning cable data services to the subscribers, including a host configuration server dynamically allocating network addresses to the CPEs, wherein the aggregation switches and the gateway server are configured to intermediate as a double-relay for initial network address request messages between the CPEs and the host configuration server, whereby the aggregation switches relay the messages to the gateway server, and the gateway server relays the messages to the host configuration server, and wherein the gateway server is operable to add host configuration server options to messages that it relays.

### CROSS REFERENCE TO RELATED APPLICATIONS

This application claims priority benefit of U.S. Provisional Application No. 62/065,683, filed on Oct. 19, 2014 by inventors Mark Chanukaev and Roy Arav, the contents of which are hereby incorporated by reference. This application also claims priority benefit of U.S. Provisional Application No. 62/077,990, filed on Nov. 11, 2014 by inventor Mark Chanukaev, the contents of which are hereby incorporated by reference.

### FIELD OF THE INVENTION

The present invention relates to provisioning of point-to-point Ethernet services using the Data over Cable Service Interface Specification (DOCSIS), and to software defined networking (SDN).

### BACKGROUND OF THE INVENTION

Data over Cable Service Interface Specification (DOCSIS) is a telecommunication standard that enables high-bandwidth data transfer over an existing Cable TV system. DOCSIS is used by cable television operators to provide their subscribers with cable Internet data services over existing all-coax or hybrid fiber-coax (HFC) infrastructures. DOCSIS includes an extensive Operations Support System (OSS) for network provisioning.

In some locations, cable operators have access to point-to-point Ethernet cables, instead of HFC cables. However, it would be very costly and time-consuming to develop a new network provisioning system for point-to-point Ethernet. It would thus be of great advantage to be able to re-use existing DOCSIS provisioning systems for point-to-point Ethernet.

Reference is made to FIG. 1, which is a simplified block diagram of a conventional cable system. FIG. 1 shows components including a plurality of cable modems, an OSS including a Dynamic Host Configuration Protocol (DHCP) server and a Trivial File Transfer Protocol (TFTP) server, a cable modem termination system (CMTS), a router, a regional network and an HFC network.

### SUMMARY OF THE DESCRIPTION

Embodiments of the present invention provide systems and methods for re-using existing DOCSIS OSS provisioning systems, for provisioning of point-to-point Ethernet data services, thereby obviating the need for cable operators to develop a new network provisioning system for use with point-to-point Ethernet cables.

Embodiments of the present invention enable the same management and provisioning capabilities of conventional coax deployments to point-to-point Ethernet deployments, with seamless connectivity to the DOCSIS OSS. In order to enable such capabilities, embodiments of the present invention provide (i) Dynamic Host Configuration Protocol (DHCP) capability via DOCSIS OSS, (ii) translation of DOCSIS configuration files to switch configurations, and (iii) scalable Simple Network Management Protocol (SNMP) capability.

There is thus provided in accordance with an embodiment of the present invention a system for provisioning of point-to-point Ethernet data services via a cable provisioning infrastructure, including a multiple dwelling unit for a plurality of cable operator subscribers, including a plurality of subscriber customer premises equipment (CPEs), each CPE having a unique identifier, and one or more floor switches, each floor switch including one or more customer-facing ports, wherein each CPE is connected to one of the customer-facing ports, and each customer-facing port of each floor switch stores the unique identifiers of the CPEs connected to that floor switch, in an identifier database, and a cable operator distribution hub, including one or more aggregation switches, wherein each floor switch is connected to one aggregation switch, a gateway server, connected to the distribution hub, and an operations support system server, connected to the gateway server, operable to provision cable data services to the subscribers, including a dynamic host configuration server operative to dynamically allocate network addresses to the CPEs, wherein the aggregation switches and the gateway server are configured to intermediate as a double-relay for initial network address request messages between the CPEs and the dynamic host configuration server, whereby the aggregation switches relay the messages to the gateway server, and the gateway server relays the messages to the dynamic host configuration server, and wherein the gateway server is operable to add dynamic host configuration server options to messages that it relays, and to remove dynamic host configuration server options from reply messages that it receives from the dynamic host configuration server.

There is additionally provided in accordance with an embodiment of the present invention a system for provisioning of point-to-point Ethernet data services via a cable provisioning infrastructure, including a multiple dwelling unit for a plurality of cable operator subscribers, including a plurality of subscriber customer premises equipment (CPEs), each CPE having a unique identifier, and one or more floor switches, each switch including one or more customer-facing ports, and a cable operator distribution hub, including one or more aggregation switches, wherein each floor switch is connected to one aggregation switch, an operations support system server, connected to the distribution hub, storing subscriber configuration files including classification rules and priority attributes of subscribed-to data services, and operative to provision one or more cable data services from a cable operator network to each subscriber CPE, and a gateway server, connected to the operations support system server, operative to translate the subscriber configuration files to floor switch configurations and aggregation switch configurations, wherein (i) each floor switch is operative to classify frames that it receives from CPEs to data services, to prioritize the thus-classified frames, into queues, and to enforce service level agreements for those data services, in the direction from the CPEs to the cable operator network, and (ii) each aggregation switch is operative to classify frames that it receives from the cable operator network to data services, to prioritize the thus-classified frames into queues, and to enforce service level agreements for those data services, in the direction from the cable operator network to said CPEs.

There is further provided in accordance with an embodiment of the present invention a system for managing network devices, including a plurality of managed devices, each device having a unique network address, and a gateway server operable to manage the managed devices, including a common network management agent for use with the managed devices, the network management agent having a switchable context and configured to allow access to different network management elements that belong to the managed devices, and a network management dispatcher configured to monitor network management protocol messages on network addresses of the managed devices, to switch the context of the network management agent to the context of a specific managed device when a network management protocol message arrives for a network address of that specific managed device, by updating the context of said network management agent to the context of the specific managed device, and by storing the previous context of the management agent prior to the updating, and to perform an action that accesses the managed device management elements in accordance with the management protocol message.

There is yet further provided in accordance with an embodiment of the present invention a method for using a cable operations support system infrastructure for provisioning point-to-point Ethernet data services, including relaying initial address request messages between a cable operator subscriber's customer premises equipment (CPE) and a dynamic address allocation server via both an aggregation switch of a cable distribution hub and a gateway server, adding, by the gateway server, dynamic address allocation server options to messages that it relays, and removing, by the gateway server, dynamic address allocation server options from reply messages that it receives from the dynamic address allocation server.

There is moreover provided in accordance with an embodiment of the present invention a method for using a cable operations support system infrastructure for provisioning point-to-point Ethernet data services, including configuring an aggregation switch in a cable distribution hub with an access control list (ACL) to perform the following actions, there being an ACL for each subscriber customer premises equipment (CPE) and subscribed-to data services, for a multiple dwelling unit of subscribers to cable data services via a cable operator network, each ACL including a data service classification rule based on a configuration file of a subscriber's cable modem: to receive frames of cable data from the operator network, to classify the received frames to data services, based on the ACLs, to prioritize the thus-classified frames into queues, and to enforce service level agreements for the thus-classified data services, in the direction from the cable operator network to the CPEs.

There is additionally provided in accordance with an embodiment of the present invention a method for managing network devices, including monitoring network management protocol messages on network addresses of a network of managed devices, each of which has a corresponding network management context including device configuration information, detecting a network management protocol message arriving for a network address of a specific managed device, identifying the context of the specific managed device based on its network address, switching the context of a network management agent, common to all of the managed devices, to the thus-identified context, including updating the context of the network management agent according to the context of the specific managed device, and storing the previous context of the network management agent prior to the updating, and accessing, by the network management agent, management elements, in accordance with the detected network management protocol message.

### BRIEF DESCRIPTION OF THE DRAWINGS

The present invention will be more fully understood and appreciated from the following detailed description, taken in conjunction with the drawings in which:

FIG. 1 is a simplified block diagram of a conventional cable system;

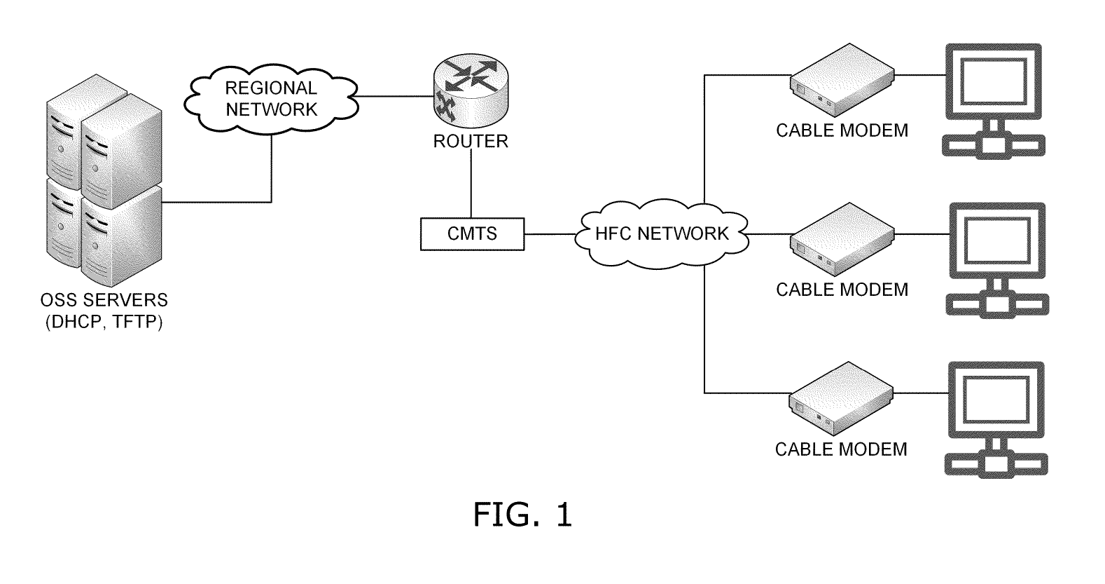

FIG. 2 is a simplified block diagram of a cable system that uses Data over Cable Service Interface Specification (DOCSIS), in accordance with an embodiment of the present invention;

FIG. 3 is a simplified block diagram of a double-relay Dynamic Host Configuration Protocol (DHCP) architecture for provisioning IP addresses to CPEs, compliant with DOCSIS OSS, in accordance with an embodiment of the present invention;

FIG. 4 is a simplified flowchart of a method for provisioning initial IP addresses to CPEs using a double-relay DHCP architecture, compliant with DOCSIS OSS, in accordance with an embodiment of the present invention;

FIG. 5 is a simplified flowchart of a method for provisioning renewal IP addresses to CPEs using a double-relay DHCP architecture, compliant with DOCSIS OSS, in accordance with an embodiment of the present invention;

FIG. 6 is a simplified flowchart of a method for translating DOCSIS configuration files to switch configurations, in accordance with an embodiment of the present invention;

FIG. 7 is a simplified block diagram of a scalable Simple Network Management Protocol (SNMP) system architecture, in accordance with an embodiment of the present invention; and

FIG. 8 is a simplified flowchart of a method for implementing a scalable Simple Network Management Protocol (SNMP) architecture, in accordance with an embodiment of the present invention.

The following acronyms are introduced and used in the description.
ACL—access control list
CM—cable modem
CMTS—cable modem termination system
DHCP—Dynamic Host Configuration Protocol
DOCSIS—Data over Cable Service Interface Specification
DPoP—DOCSIS provisioning of point-to-point Ethernet
HFC—hybrid fiber-coax
LAN—local area network
MAC—media access control
MDU—multiple dwelling unit
MIB—Management Information Base
OSS—Operations Support System
SDN—Software Defined Networking
SNMP—Simple Network Management Protocol
TFTP—Trivial File Transfer Protocol

For reference to the figures, the following index of elements and their numerals is provided. Similarly numbered elements represent elements of the same type, but they need not be identical elements. Operations of methods are numbered in the 1000's.

Table of elements in the figures

| Element | Description |
|---|---|
| 100 | multiple dwelling unit |
| 110 | CPE |
| 120 | floor switches |
| 125 | DHCP helper |
| 200 | business site |
| 210 | Business CPEs |
| 220 | demarcation devices |
| 300 | distribution hub |
| 320 | aggregation switches |
| 325 | DHCP relay agent |
| 330 | edge router |
| 400 | back office network |
| 410 | DPoP server |
| 415 | DPoP DHCP relay agent |
| 440 | DOCSIS OSS servers |
| 445 | OSS DHCP server |
| 450 | operator regional network |
| 600 | SNMP system |
| 660 | SNMP dispatcher |
| 670 | SNMP agent |
| 680 | context table |
| 690 | MIB database |

### DETAILED DESCRIPTION

Aspects of the present invention relate to use of a DOCSIS infrastructure for provisioning of point-to-point Ethernet data services.

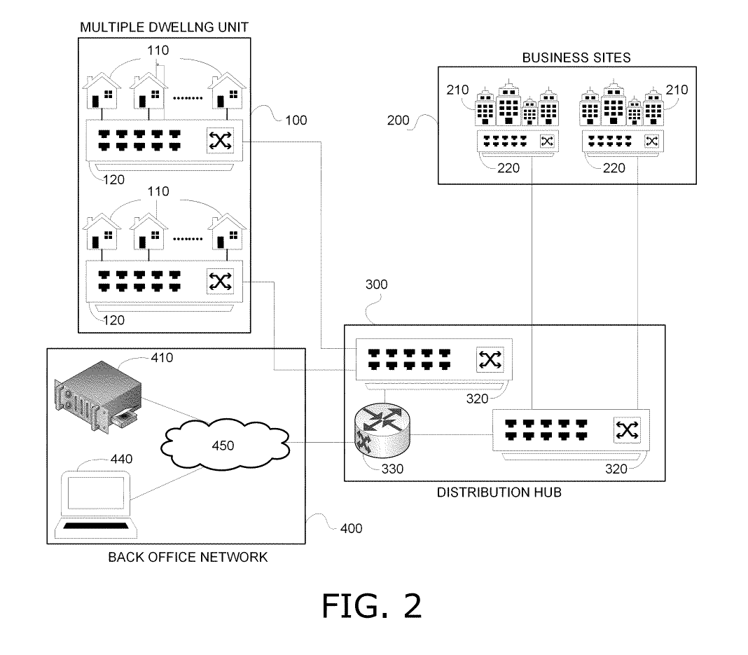

Reference is made to FIG. 2, which is a simplified block diagram of a cable system that uses Data over Cable Service Interface Specification (DOCSIS), in accordance with an embodiment of the present invention. FIG. 2 shows four major components; namely, multiple dwelling unit (MDU) 100, business sites 200, distribution hubs 300 and a back office network 400. MDU 100 includes homes with customer premises equipment (CPE) 110, and floor switches 120. Each floor switch 120 includes one or more local area network (LAN) ports, and stores one or more media access control (MAC) addresses of CPEs 110 in a MAC address table. Each LAN port of a floor switch 120 is used by a single subscriber. Business sites 200 include business services sites 210, and demarcation devices 220. Distribution hubs 300 include aggregation switches 320 and edge router 330. Back office network 400 includes a DOCSIS provisioning of point-to-point Ethernet (DPoP) server 410, operations support system (OSS) servers 440, and an operator's regional network 450.

In accordance with an embodiment of the present invention, each CPE 110 is connected to a single floor switch 120, each floor switch 120 is connected to a single aggregation switch 320, each aggregation switch 320 is connected to one or more floor switches 120, and each demarcation device 220 is connected to a single floor switch or to a single aggregation switch. DPoP 410, DOCSIS OSS servers 440 and aggregation switches 320 are connected to edge router 330, either directly or via switches in regional network 450.

Embodiments of the present invention enable the system of FIG. 2 to offer the same management and provisioning capabilities as conventional coax deployments, with seamless connectivity to the DOCSIS OSS. In order to enable such capabilities, embodiments of the present invention provide (i) Dynamic Host Configuration Protocol (DHCP) capability for CPEs compliant with DOCSIS OSS, (ii) translation of DOCSIS configuration files to switch configurations, and (iii) scalable Simple Network Management Protocol (SNMP) architecture. Each of these features is described in detail hereinbelow.

I. DOSCSIS OSS Compliant DHCP Capability for CPEs

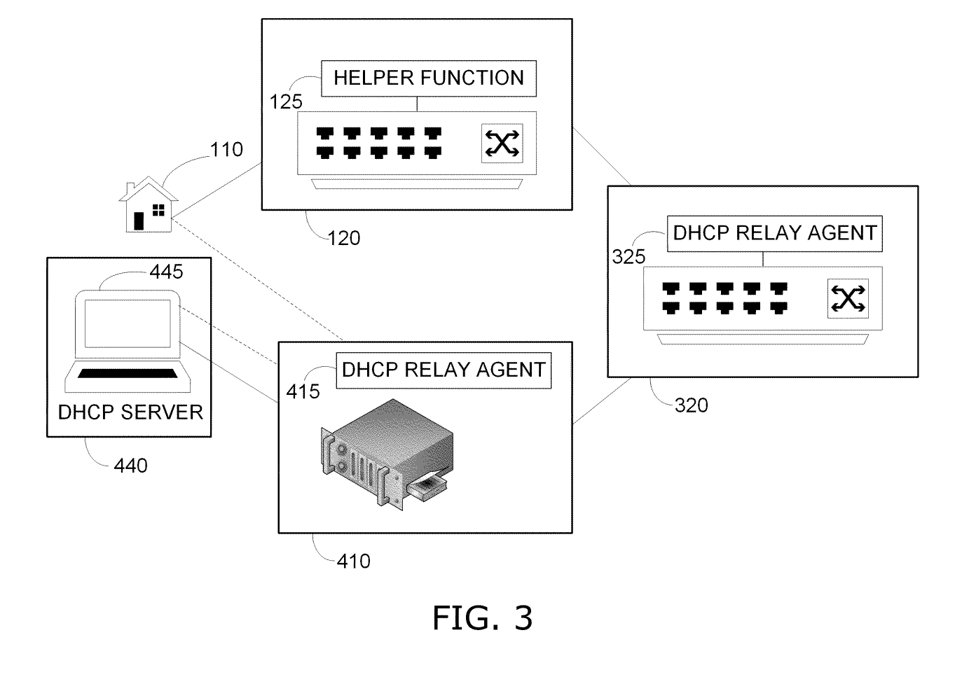

Reference is made to FIG. 3, which is a simplified block diagram of a double-relay Dynamic Host Configuration Protocol (DHCP) architecture for provisioning IP addresses to CPEs, complaint with DOCSIS OSS, in accordance with an embodiment of the present invention. DHCP is a network protocol used on IP networks for dynamically distributing network configuration parameters, such as IP addresses, for interfaces and services.

The DHCP protocol provides for vendor-specific options. The DOCSIS-specific DHCP options include inter alia (i) for address allocation requests, cable modem information such as type, software and hardware version, and (ii) for allocation requests of a CPE connected to the cable modem, a cable modem assigned IP address.

FIG. 3 shows CPE 110, DPoP server 410 with a DPoP DHCP relay agent 415, a floor switch 120 with an optional DHCP helper 125, an aggregation switch 320 with a DHCP relay agent 325, and DOCSIS OSS servers 440 including an OSS DHCP server 445. Under DHCP, network nodes request IP addresses and networking parameters automatically from a DHCP server, eliminating the need for a network administrator or a user to manually configure these settings. Under DOCSIS, a CPE 110 connected to a cable modem (CM) is assigned an IP address by OSS DHCP server 445.

Use of a DOCSIS provisioning infrastructure for assigning IP addresses to CPEs leads to several technical challenges which need to be overcome, as described hereinbelow.
Technical Challenge—Aggregation switch 320 blocks broadcast frames.

Since aggregation switch 320 is connected to edge router 330, it must act as a router as well when communicating with edge router 330. By default, a router blocks IP broadcast frames. However, some DHCP messages generated by CPE 110 are IP broadcast and multi-cast frames. As such, aggregation switch 320 must perform a DHCP relay function that overwrites the broadcast/multi-cast destination address in DHCP messages to a uni-cast destination address of a pre-configured network node. In accordance with an embodiment of the present invention, this address is configured to be the address of DPoP server 410.
Technical Challenge—Aggregation switch 320 is not DOCSIS aware, and cannot add and remove DOCSIS-specific DHCP options to messages it relays between OSS DHCP server 445 and CPE 110.

DOCSIS OSS DHCP server 445 is programmed to send and receive DOCSIS-specific DHCP options, whereas the DHCP client of CPE 110 is not DOCSIS-aware and, as such, cannot send and receive these options. DHCP messages cannot be relayed by aggregation switch 320 directly from CPE 110 to DOCSIS OSS DHCP server 445, because aggregation switch 320 is not DOCSIS-aware, and cannot add DOCSIS-specific DHCP options to message originated by CPE 110, and cannot remove DOCSIS-specific DHCP options from messages destined to CPE 110. However, DPoP server 410 is DOCSIS-aware, and its DPoP DHCP relay agent 415 can add and remove the DOCSIS-specific DHCP options as required.

In accordance with an embodiment of the present invention, a double DHCP relay is performed. Specifically, aggregation DHCP relay agent 325 is pre-configured to relay DHCP messages to DPoP server 410, and DPoP DHCP relay agent 415 is pre-configured to relay DHCP messages to OSS DHCP server 445.
Technical Challenge—When OSS DHCP server 445 receives a message from a CPE 110, it may need to identify that CPE in order to process the message, but under DOCSIS a CPE is identified based on the cable modem (CM) to which it is attached.

DOCSIS OSS DHCP server 445 must identify CPE 110, in order to determine if to assign an IP address to it and, if so, what IP address to assign. Under DOCSIS, CPE identification is based on identification of the cable modem (CM) to which the CPE is attached. In accordance with an embodiment of the present invention, the CM is identified according to the MAC address of the floor switch LAN port 120 to which a CPE is connected.

In one embodiment of the present invention, when a DHCP message arrives from a CPE 110, the floor switch LAN port 120 of that CPE is identified by means of DHCP helper 125 in floor switch 120. Specifically, DHCP helper 125 adds a DHCP option to the DHCP message from the CPE, which includes a LAN port identifier. This data is received by DPoP server 410, and DPoP DHCP relay agent 415 converts this data to a proper DOCSIS-specific DHCP option.

In an alternative embodiment of the present invention, when a DHCP message arrives from a CPE 110, the floor switch LAN port 120 of that CPE is identified by extracting the MAC address of the CPE from the DHCP message in DPoP server 410, and searching for this MAC address in the MAC address tables in the floor switches 120 connected to that aggregation switch 320 via which the message arrived. When the MAC address is found, the floor switch LAN port 120 to which the CPE is connected is then identified. Under DHCP version 4, the CPE's MAC address may be extracted from the “Client ID” field in the DHCP message. Under DHCP version 6, the CPE's MAC address may be extracted from the “DUID” field in the DHCP message, or from the “Local Link IP version 6” address of the DHCP message.
Technical Challenge—A DHCP client may request renewal of its IP address allocation from time to time, but direct communication between the client and the DHCP server will fail due to missing DOCSIS-specific DHCP options in the client request.

Under DHCP, a client may request renewal of its IP address allocation from time to time. Conventionally, this is performed directly between the client and the DHCP server that allocated the IP address to the client. However, the data path of system of FIG. 2 does not go through DPoP server 410, and such a request may lead to direct communication between the DHCP client in CPE 110 and the OSS DHCP server 445, which would fail due to missing DOCSIS-specific DHCP options in the client's DHCP message.

In accordance with an embodiment of the present invention, DPoP DHCP relay agent 415 overwrites the OSS DHCP server address, in the DHCP IP address allocation message sent to the DHCP client of CPE 110, with the address of DPoP server 410, thus ensuring that future IP address renewal requests by CPE 110 are sent to DPoP server 410. DPoP DHCP relay agent 415 changes the destination address of the message to the address of the OSS DHCP server 445 and adds the required DOCSIS-specific DHCP options. DPoP server 410 then relays the messages to OSS DHCP server 445. The CPE DHCP renewal IP request messages traverse the following logical path: CPE 110⇄DPoP DHCP relay agent 415⇄OSS DHCP server 445.
Technical Challenge—In certain cases, OSS DHCP server 445 does not accept DHCP version 6 messages that were relayed by two of more DHCP version 6 relay agents.

Under DHCP version 6, each relay between a client and the server adds a relay agent message header option identifying its existence. In some cases OSS DHCP server 445 does not accept DHCP version 6 messages that were relayed by two or more such relay agents. Moreover, in the double-relay system of FIG. 3 there are two relay agents; namely, relay agent 325 and DPoP DHCP relay agent 415.

In accordance with an embodiment of the present invention, DPoP DHCP relay agent 415 overwrites the aggregation switch relay agent relay header option with its own relay header option, thus making the double relay appear as a single relay. DPoP DHCP relay agent 415 saves the overwritten information in a database, in order that the aggregation switch relay agent relay header option is restored for communication in the opposite direction. The overwritten information incudes inter alia “Interface ID” and “Link Address” fields.

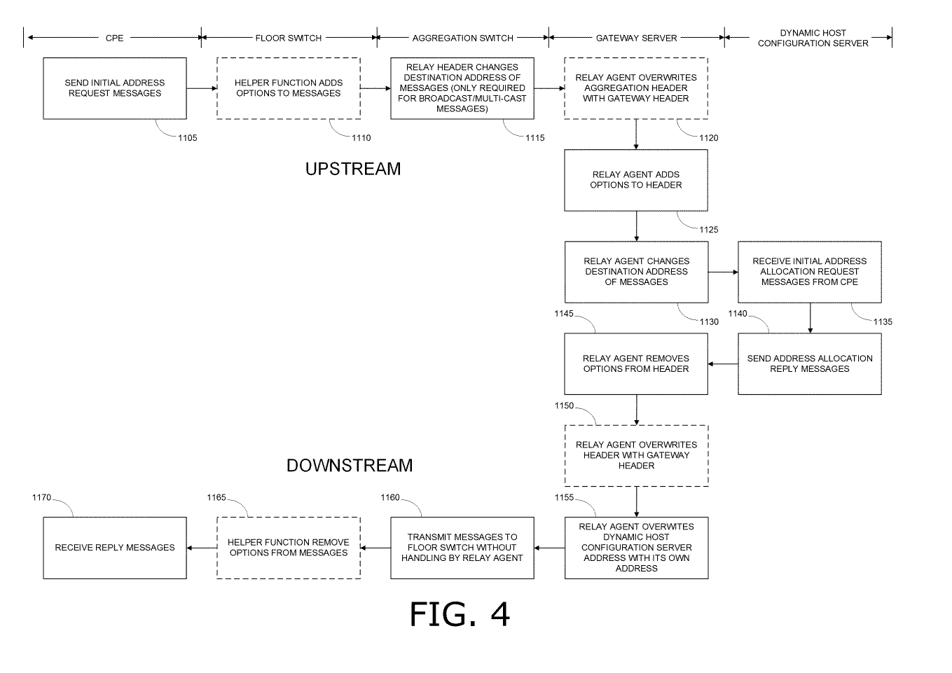

Reference is made to FIG. 4, which is a simplified flowchart of a method for provisioning initial IP addresses to CPEs using a double-relay DHCP architecture, compliant with DOCSIS, in accordance with an embodiment of the present invention. The flowchart of FIG. 4 is divided into five columns. The leftmost column indicates operations performed by a CPE, such as CPE 110. The column second to the left indicates operations performed by a floor switch, such as floor switch 120. The middle column indicates operations performed by an aggregation switch, such as aggregation switch 320. The column second to the right indicates operations performed by a gateway server, such as DPoP server 410. The rightmost column indicates operations performed by a dynamic host configuration server, such as OSS DHCP server 445. Operations 1105-1135 flow in the upstream direction, from the CPE to the dynamic host configuration server. Operations 1140-1170 flow in the downstream direction, from the dynamic host configuration server to the CPE.

At operation 1105, the CPE sends initial address request messages to the dynamic host configuration server via the floor switch. Operation 1110 is optional, and is performed when the floor switch includes a helper function, such as helper function 125. At operation 1110, the helper function adds options, such as DHCP options, to the messages. At operation 1115, a relay agent in the aggregation switch, such as relay agent 325, changes the destination address of the messages and optionally adds a relay header option, and the aggregation switch transmits the messages to the gateway server. Use of the relay agent is only necessary for broadcast and multi-cast messages. Operation 1120 is optional, and is performed when the dynamic host configuration server does not accept address request messages that were relayed by two relay agents. At operation 1120, a relay agent in the gateway server, such as relay agent 415, stores the aggregation switch relay header relay option in a database and overwrites the aggregation switch relay agent relay header option with its own relay header option. At operation 1125, the relay agent of the gateway server adds options, such as DOCSIS DHCP options, to the header. At operation 1130, the relay agent in the gateway server changes the destination address of the messages, and the gateway server transmits the messages to the dynamic host configuration server. Finally, at operation 1135, the dynamic host configuration server receives the initial address allocation request messages.

At operation 1140, the dynamic host configuration server sends reply messages to the CPE, via the gateway server. At operation 1145, the relay agent in the gateway server removes options, such as DOCSIS DHCP options, from the header. Operation 1150 is optional, and is performed if operation 1120 was performed. At operation 1150 the relay agent in the gateway server overwrites the relay header option with its own relay header option. At operation 1155, the relay agent overwrites the dynamic host configuration server address with its own address. Operation 1155 ensures that the client in CPE 110 requests address renewals from DPoP relay agent 415, instead of from OSS DHCP server 445. The gateway server then transmits the message to the aggregation switch. At operation 1160, the aggregation switch transmits the message to the floor switch without handling by its relay agent. Use of the relay agent is not required at operation 1160, since the reply messages are uni-cast messages. Operation 1160 is an optional operation. If the floor switch helper function added options to the request messages at operation 1110, then the helper function removes these options from the messages at operation 1160. Finally, at operation 1165, the CPE receives the address allocation reply messages.

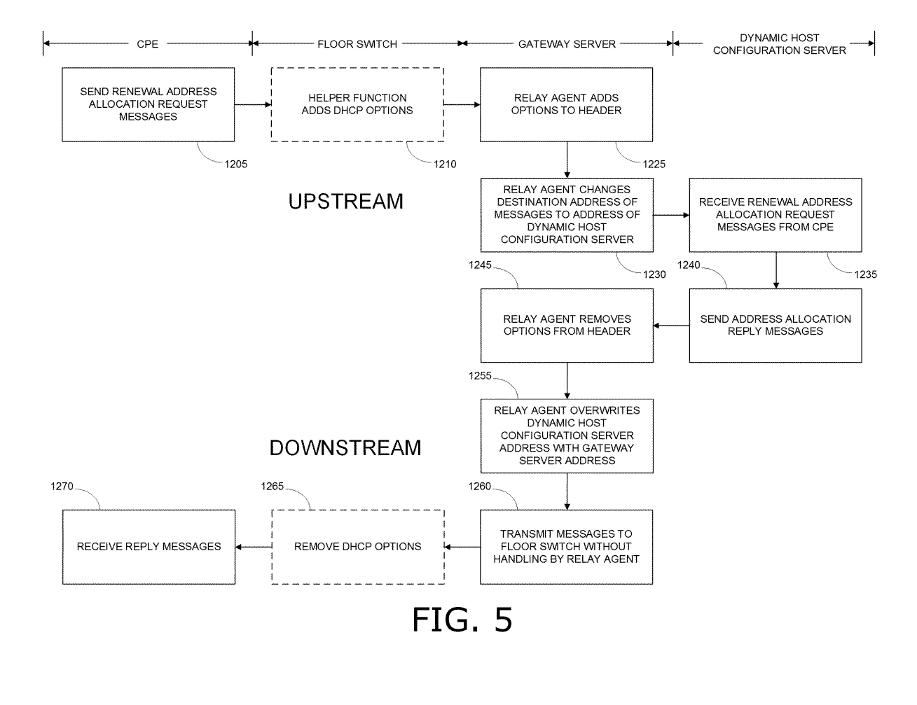

Reference is made to FIG. 5, which is a simplified flowchart of a method for provisioning renewal IP addresses to CPEs using a double-relay DHCP architecture, compliant with DOCSIS, in accordance with an embodiment of the present invention. The flowchart of FIG. 5 is divided into four columns. The leftmost column indicates operations performed by a CPE, such as CPE 110. The column second to the left indicates operations performed by a floor switch, such as floor switch 120. The column second to the right indicates operations performed by a gateway server, such as DPoP server 410. The rightmost column indicates operations performed by a dynamic host configuration server, such as OSS DHCP server 445. Operations 1205-1335 flow in the upstream direction, from the CPE to the dynamic host configuration server. Operations 1240-1270 flow in the downstream direction, from the dynamic host configuration server to the CPE.

At operation 1205, the CPE sends renewal address allocation request messages to the gateway server via the floor switch. Operation 1210 is optional, and is performed when the floor switch include a helper function, such as helper function 125. At operation 1210, the helper function adds options, such as DHCP options, to the messages. At operation 1225, the relay agent in the gateway server, such as relay agent 415, adds options, such as DOCSIS DHCP options, to the header. At operation 1230, the gateway server changes the destination address of the messages to the address of the dynamic host configuration server. Finally, at operation 1235, the dynamic host configuration server receives the renewal address allocation request messages.

At operation 1240, the dynamic host configuration server sends reply messages to the CPE, via the gateway server. At operation 1245, the relay agent in the gateway server removes options, such as DOCSIS DHCP options, from the header. At operation 1255, the relay agent in the gateway server overwrites the dynamic host configuration server address with the gateway server address. At operation 1260 the gateway server transmits the message to the floor switch without handling by its relay agent. Operation 1265 is an optional operation. If the floor switch help function added options to the request messages at operation 1210, then the helper function removes those options from the messages at operation 1265. Finally, at operation 1270, the CPE receives the address allocation reply message.

II. Translation of DOCSIS Configuration Files to Switch Configurations

Trivial File Transfer Protocol (TFTP) is used for configuring a network device during its boot process. Conventional DOCSIS provisioning relies on a configuration file that is downloaded from a DOCSIS OSS TFTP server by a CM. The configuration file contains many elements, including inter alia
service classification and prioritization
service level agreement (SLA)
limitation on the number of CPEs that connect to the CM.

Under conventional DOCSIS, service classification and SLA enforcement in the downstream direction are performed at the cable modem termination system (CMTS), and service classification and SLA enforcement in the upstream direction are performed at the CM. The downstream direction refers to the direction from network 450 to a CPE 110, and the upstream direction refers to the direction from a CPE 110 to network 450.

In accordance with an embodiment of the present invention, aggregation and floor switches are configured to perform service classification, prioritization and SLA enforcement, with the same expected behavior as if the classification, prioritization and enforcement were performed by the CMTS and by the CM.

### Downstream Direction

In the downstream direction, aggregation switch 320 is configured to act as the CMTS. Aggregation switch 320 is configured with access control lists (ACLs) to classify frames according to data services. ACLs are built for each subscriber's CPE and for each data service that the subscriber is subscribed to. Each ACL's classification conditions include the service's downstream classification rule from the configuration file of the subscriber's CM, with the additional condition that an incoming frame must have the CPE's IP address as its destination IP address. The ACL points to an aggregation switch policer that enforces the SLA of the service to which the classification rules belongs. Several ACLs may point to a common policer when aggregated rate-limiting of a subscriber's services is required. The ACLs are ordered based on their precedence in the configuration file. This is performed by adding the classification rules in decreasing precedence order. Alternatively, this may be done by indicating rule precedence, if aggregation switch 320 supports this.

In a DOCSIS configuration file of a subscriber's CM, each data service has a service priority attribute, which determines service priority vis-à-vis other Aggregation switch 320 directs frames matching an ACL to a queue based on the service priority attribute of the data service that is classified using that ACL. Generally, there are more service priority values than queues and, as such, many service priorities may be mapped to a single queue.

### Upstream Direction

Each LAN port of floor switch 120 is used by a single subscriber, and each LAN port of floor switch 120 is configured to act as a CM. The limitation on the number of CPEs 110 that connect to the CM is enforced by limiting the number of learned MAC addresses per LAN port of floor switch 120. Furthermore, floor switch 120 is configured to discard frames arriving in the upstream direction when its MAC source address field is unknown, thereby effectively limiting the number of CPEs that can send their traffic to network 450.

In the upstream direction, floor switch 120 is configured with ACLs to classify frames according to data services. An ACL is built for each subscriber's data service. The ACL's classification includes the service's upstream classification rule in the configuration file of the subscriber's CM. The ACL points to a floor switch policer that enforces the SLA of the data service to which the classification rule belongs. Several ACLs may point to a single policer, when aggregated rate-limiting of a subscriber's service is required. The ACLs are ordered based on their precedence in the configuration file. This may be done by adding the classification rules in decreasing precedence order. Alternatively, this may be done by indicating rule precedence, if floor switch 120 supports this.

In accordance with an embodiment of the present invention, to support service priority, floor switch 120 maps priority fields such as “IP DSCP” to queues as a default behavior, and directs frames matching an ACL to a queue based on the DOCSIS “Service Priority” field of the data service that is classified by this ACL. Generally, there are more service priority values than queues and, as such, many service priorities may be mapped to a single queue. Floor switch 120 may also overwrite the “IP DCSP” field of incoming frames in order to homogenize the priority of different data services among different subscribers inside the service provider's network.

It is noted that less sophisticated floor switches and less expensive floor switches may not have the capabilities required to perform the above service classification and prioritization. In such case, floor switch 120 only polices the upstream traffic of each LAN port according to an aggregated rate-limiting of a subscriber's services, and maps priority fields such as “IP DSCP” to queues, and aggregation switch 320 performs similar policing actions in the upstream direction as it does in the downstream direction. In such case, an ACL is built for each subscriber's CPE and for each data service that the subscriber is subscribed to. The ACL's classification conditions include the service's upstream classification rule in the configuration file of the subscriber's CM, with the additional condition that an incoming frame must have the CPE's IP address as its source IP address. The ACL points to an aggregation switch policer that enforces the SLA of the service to which the classification rule belongs. The ACLs are ordered based on their precedence in the configuration file. This may be performed by adding the classification rules in decreasing precedence order. Alternatively, this may be done by indicating rule precedence, if the aggregation switch 320 supports this.

When aggregation switch 320 performs policing actions in the upstream direction, in order to support service priority, aggregation switch 320 maps priority fields such as “IP DSCP” to queues as a default behavior, and directs frames matching an ACL to a queue based on the DOCSIS “Service Priority” field of the data service classified by this ACL. Generally, there are more service priority values than queues and, as such, many service priorities may be mapped to a single queue. Aggregation switch 320 may also overwrite the “IP DSCP” field of incoming frames, in order to homogenize the priority of different data services among different subscribers inside a service provider's network.

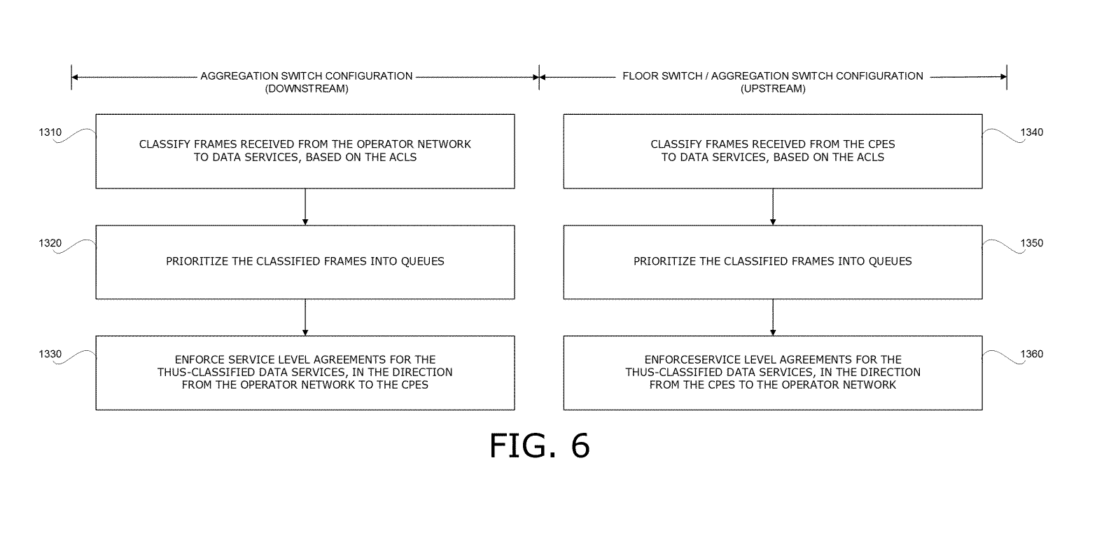

Reference is made to FIG. 6, which is a simplified flowchart of a method for translating DOCSIS configuration files to switch configurations, in accordance with an embodiment of the present invention. FIG. 6 includes two columns. The left column includes operations 1310-1330, which are performed via configuration of an aggregation switch 320 of distribution hub 300. The right column includes operations 1340-1360, which are performed via configuration of a floor switch 120, provided that the floor switches support classification and prioritization of frames. Otherwise, the operations in the right column are performed via configuration of aggregation switch 320. The left column relates to the downstream direction, from operator network 450 to CPEs 110. The right column relates to the upstream direction, from CPEs 110 to operator network 450.

In accordance with an embodiment of the present invention, ACLs are built for each subscriber CPE and for each data service that the subscriber is subscribed to, for MDU 100 of subscribers to cable data services. Each ACL includes a data service classification rule based on a subscriber's configuration file. Moreover, when operations 1340-1360 are performed via configuration of aggregation switch 320, the ACL further includes a CPE unique identifier.

At operation 1310 frames received from operator network 450 are classified by data services, based on the ACLs. At operation 1320, the thus-classified frames are prioritized into queues. At operation 1330 aggregation switch 320 enforces service level agreements for the thus-classified data services, in the direction from operator network 450 to CPEs 110.

At operation 1340 frames received from CPEs 110 are classified by data services, based on the ACLs. At operation 1350, the thus-classified frames are prioritized into queues. At operation 1360 floor switch 120 or aggregation switch 320 enforces service level agreements for the thus-classified data services, in the direction from CPEs 110 to operator network 450.

III. SNMP Capability

Simple Network Management Protocol (SNMP) is used for managing devices on an IP network. In conventional DOCSIS, each CM runs an SNMP agent that allows read and/or write access to different Management Information Base (MIB) elements. The SNMP agent is accessed through the IP address that the OSS DHCP server 445 allocated to a CM.

In accordance with an embodiment of the present invention, virtual CMs are used instead. DOCSIS-based server 410 implements these virtual CMs. It performs the DHCP process with OSS DHCP server 450 in order to allocate an IP address per virtual CM. It also holds an SNMP agent for each virtual CM. However, instead of holding a separate instance of an SNMP agent per virtual CM, which requires extensive memory and operating system resources, a single SNMP agent for all the virtual CMs is held, and a context switch mechanism is used for handling SNMP messages destined for different virtual CMs.

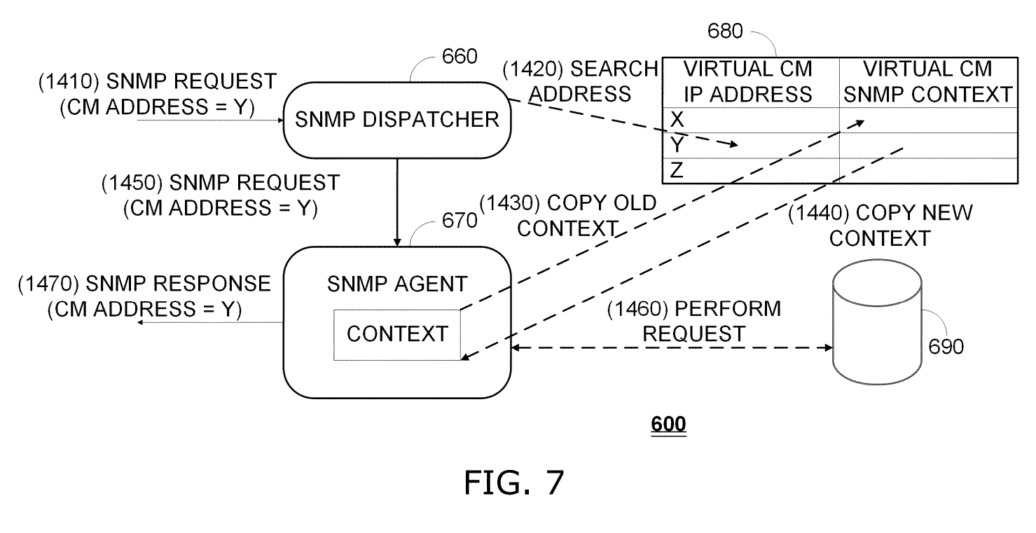

Reference is made to FIG. 7, which is a simplified block diagram of an SNMP system architecture 600, in accordance with an embodiment of the present invention. SNMP architecture 600 is a component of DPoP server 410. Shown in FIG. 6 is an SNMP dispatcher 660 and an SNMP agent 670.

At operation 1410, SNMP dispatcher 660 listens to SNMP traffic on IP addresses of the virtual CMs. When an SNMP message arrives for one of these addresses, SNMP dispatcher 660 switches SNMP agent 670 to the context of the specific instance of the virtual CM, using a context table 680 that stores a context for each virtual CM. The context includes the virtual CM IP address and its SNMP-related configuration, e.g., SNMP Address Community and SNMP Access Control. Specifically, if the address of the virtual CM in the SNMP request is Y, then at operation 1420, SNMP dispatcher 660 searches context table 680 for address Y.

When a virtual CM with address Y is found, a context switch for SNMP agent 670 is performed at operations 1430 and 1440. However, if a current message relates to a virtual CM that was previously used, no context switch for SNMP agent 670 is required. At operation 1330, the current context of SNMP agent 670, say, corresponding to a virtual CM with address X, is copied to context table 680. At operation 1340, the context of SNMP agent 670 is updated with the new virtual CM context, say, corresponding to the virtual CM with address Y. Subsequently, at operation 1450, SNMP dispatcher 660 transfers the SNMP message to SNMP agent 670. At operation 460, SNMP agent 670 performs the required action in that context, using an MIB database 690 that stores data of the SNMP MIBs for each virtual CM. The required action may change the context of the virtual CM, hence the need at operation 1430 to save the old context to context table 680. Each context change is marked, so that a context is not copied to context table 680 unnecessarily when performing a context switch. Finally, at operation 1470, SNMP agent 670 sends an SNMP response back to the sender of the original SNMP message.

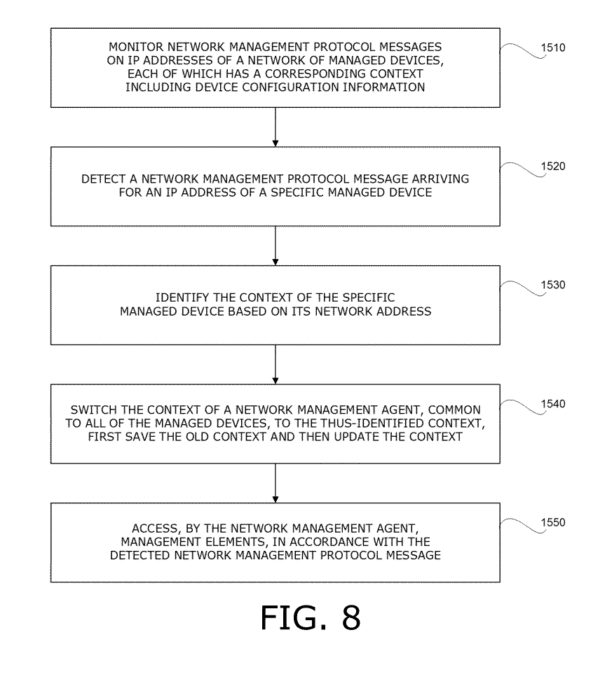

Reference is made to FIG. 8, which is a simplified flowchart of a method for provisioning Simple Network Management Protocol (SNMP) capability, in accordance with an embodiment of the present invention. At operation 1510 protocol messages are monitored. Other non-protocol traffic is not monitored. Specifically, at operation 1510 network management protocol messages, such as SNMP messages, on IP addresses of a network of managed devices is monitored, each managed device having a corresponding context comprising device configuration information, such as SNMP configuration information. At operation 1520 a network management protocol message arriving for an IP address of a specific managed device is detected. At operation 1530 the context of the specific managed device is detected, based on its IP address. At operation 1540 the context of a network management agent, such as an SNMP agent, common to all of the managed devices, is switched to the thus-identified context. Prior to updating its context, the current context of the network management agent is stored in a context database. At operation 1550, the network management agent accesses management elements, such as MIBs, of the specific managed device, in accordance with the detected network management protocol message. Operation 1550 may change the context of the network management agent, hence the need at operation 1540 to store the old context.

The methods of FIGS. 4, 5, 6 and 8 may be practiced separately or in combination, by the system of FIG. 2.

Having read the above description, it will be appreciated by those skilled in the art that the scalable SNMP capability of the present invention is not limited to DOCSIS provisioning architecture, and applies broadly to other systems where a server needs to act as an SNMP agent for a large number of devices.

Although the above description relates specifically to MDUs, the systems and methods described above relate to business sites as well, whereby demarcation devices 220 (FIG. 2) are configured similarly to floor switches 120 by DPoP server 410, and business CPEs are regarded as residential CPEs.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A system for provisioning of point-to-point Ethernet data services via a cable provisioning infrastructure, comprising:
a multiple dwelling unit for a plurality of cable operator subscribers, comprising:
a plurality of subscriber customer premises equipment (CPEs), each CPE having a unique identifier; and
one or more floor switches, each floor switch comprising one or more customer-facing ports, wherein each CPE is connected to one of the customer-facing ports, and each customer-facing port of each floor switch stores the unique identifiers of the CPEs connected to that floor switch, in an identifier database; and
a cable operator distribution hub, comprising one or more aggregation switches, wherein each floor switch is connected to one aggregation switch;
a gateway server, connected to said distribution hub; and
an operations support system server, connected to said gateway server, operable to provision cable data services to the subscribers, comprising a dynamic host configuration server operative to dynamically allocate network addresses to said CPEs,
wherein said aggregation switches and said gateway server are configured to intermediate as a double-relay for initial network address request messages between said CPEs and said dynamic host configuration server, whereby said aggregation switches relay the messages to said gateway server, and said gateway server relays the messages to said dynamic host configuration server, and
wherein said gateway server is operable to add dynamic host configuration server options to messages that it relays, and to remove dynamic host configuration server options from reply messages that it receives from said dynamic host configuration server.

2. The system of claim 1 wherein said gateway server is further operable to overwrite an aggregation switch relay header with its own header, in the initial network address request messages being relayed from an originating CPE to said dynamic host configuration server, thus making the double-relay appear as a single-relay, and to restore the aggregation switch relay header in reply messages being relayed from said dynamic host configuration server to the originating CPE.

3. The system of claim 1, wherein said gateway server is further configured to overwrite the address of said dynamic host configuration server in renewal network address request messages being relayed from an originating CPE to said dynamic host configuration server, with the address of said gateway server, so that such request messages are transmitted to said gateway server, which in turn relays the request messages to said dynamic host configuration server.

4. The system of claim 1, wherein said gateway server is further configured to extract information from a message being relayed from an originating CPE to said dynamic host configuration server, and to use the thus-extracted information to identify the customer-facing port of the floor switch to which the originating CPE is attached.

5. The system of claim 4, wherein said gateway server searches for the thus-extracted information in the identifier databases in the customer-facing ports of those of said floor switches connected to that aggregation switch that relayed the message from the originating CPE to said gateway server.

6. The system of claim 1, wherein said floor switches employ a helper function, configured to add a customer-facing port identifier to the message being relayed from an originating CPE to said dynamic host configuration server, thereby enabling said gateway server to identify the floor switch customer-facing port to which the originating CPE is attached.

7. The system of claim 1, wherein each floor switch is configured to limit the number of CPE unique identifiers that it stores per customer-facing port.

8. A system for provisioning of point-to-point Ethernet data services via a cable provisioning infrastructure, comprising:
a multiple dwelling unit for a plurality of cable operator subscribers, comprising:
a plurality of subscriber customer premises equipment (CPEs), each CPE having a unique identifier; and
one or more floor switches, each switch comprising one or more customer-facing ports; and
a cable operator distribution hub, comprising one or more aggregation switches, wherein each floor switch is connected to one aggregation switch;
an operations support system server, connected to said distribution hub, storing subscriber configuration files comprising classification rules and priority attributes of subscribed-to data services, and operative to provision one or more cable data services from a cable operator network to each subscriber CPE; and
a gateway server, connected to said operations support system server, operative to translate the subscriber configuration files to floor switch configurations and aggregation switch configurations, wherein (i) each floor switch is operative to classify frames that it receives from CPEs to data services, to prioritize the thus-classified frames, into queues, and to enforce service level agreements for those data services, in the direction from said CPEs to the cable operator network, and (ii) each aggregation switch is operative to classify frames that it receives from the cable operator network to data services, to prioritize the thus-classified frames into queues, and to enforce service level agreements for those data services, in the direction from the cable operator network to said CPEs.

9. The system of claim 8, wherein said aggregation switch is configured with an access control list (ACL) to classify frames to data services, an ACL being provided for each subscriber CPE and data service, each ACL comprising a CPE's unique identifier and a data service classification rule based on a subscriber's configuration file.

10. The system of claim 9, wherein said aggregation switch is configured to prioritize the frames into queues based on the service priority attribute of the data service to which the frames are classified, thereby enforcing service priorities.

11. The system of claim 8, wherein each floor switch is configured with an access control list (ACL) to classify frames to data services, an ACL being provided for each subscriber CPE and data service, each ACL comprising a data service classification rule based on a subscriber's configuration file.

12. The system of claim 11, wherein each floor switch is configured to prioritize the frames into queues based on the service priority attribute of the data service to which the frames are classified, thereby enforcing service priorities.

13. A method for using a cable operations support system infrastructure for provisioning point-to-point Ethernet data services, comprising:
relaying initial address request messages between a cable operator subscriber's customer premises equipment (CPE) and a dynamic address allocation server via both an aggregation switch of a cable distribution hub and a gateway server;
adding, by the gateway server, dynamic address allocation server options to messages that it relays; and
removing, by the gateway server, dynamic address allocation server options from reply messages that it receives from the dynamic address allocation server.

14. The method of claim 13 further comprising:
overwriting, by the gateway server, an aggregation switch relay header with its own header, in the initial network address request messages being relayed from the CPE to the dynamic address allocation server, thus making the double relay appear as a single relay; and
restoring, by the gateway server, the aggregation switch relay header in reply messages being relayed from the dynamic address allocation server to the CPE.

15. The method of claim 13, further comprising overwriting the address of the dynamic address allocation server in renewal network address request messages being relayed from an originating CPE to the dynamic address allocation server, with the address of the gateway server, so that such messages are instead transmitted to the gateway server, which in turn relays the request messages to the dynamic address allocation server.

16. The method of claim 13, further comprising:
extracting, by the gateway server, information from a message relayed from a CPE to the dynamic network address allocation server; and
identifying a floor switch customer-facing port to which the CPE is attached, based on the thus-extracted information.

17. The method of claim 16, wherein the CPE is located within a multiple dwelling unit comprising many cable operator subscribers, and wherein said identifying comprises searching, by the gateway server, for the thus-extracted information in identifier databases of floor switches of the multiple dwelling unit that are connected to the aggregation switch that relayed the message from the CPE to the gateway server.

18. The method of claim 16, wherein the CPE is located within a multiple dwelling unit comprising many cable operator subscribers, the method further comprising adding, by a floor switch of the multiple dwelling unit, a customer-facing port identifier to a message being relayed from the CPE to the dynamic network address allocation server, and wherein said identifying is based on the customer-facing port identifier.
